(19) United States
(12) Patent Application Publication
(10) Pub. No.: US 2003/0163483 A1
(43) Pub. Date: Aug. 28, 2003

(54) Method and system for a data service to control access to personal information

(76) Inventors: Abraham Zingher, Beach Park, IL (US); Joseph Zingher, Glendale Heights, IL (US)

Correspondence Address: MCDONNELL BOEHNEN HULBERT & BERGHOFF, 300 SOUTH WACKER DRIVE, SUITE 3200, CHICAGO, IL, 60606, US

(21) Appl. No.: 10/079,050

(22) Filed: Feb. 19, 2002

(51) Int. Cl. G06F 7/00; G06F 17/00; G06N 5/02; G06F 17/60

(52) U.S. Cl. 707/104.1; 705/1

(57) ABSTRACT

A method and system for a data service to gather, manage, and control access to personal information associated with an individual. The personal information may include an individual's financial records, medical records, motor vehicle records, and criminal records. The data service may collect the personal information from at least one third-party database, store the personal information in a local database, and actively verify whether the personal information is accurate. The data service may also allow the individual to remove all or selected personal information stored in the local database.

### BACKGROUND

1. Field of the Invention

The present invention relates to data services and more particularly to a method and system for controlled access to personal information associated with an individual.

2. Description of the Related Art

For years, credit bureaus have been collecting financial information. Credit bureaus such as Equifax and Trans Union, for example, collect financial information associated with individuals in the form of credit reports.

A bank or credit agency may use the credit reports to make informed decisions. For example, if an individual applies for a loan or extension of credit, the bank or credit agency may obtain the credit report associated with the individual. The bank or credit agency may request the credit report from one or more credit bureaus and the one or more credit bureaus may compile the credit report. The credit report typically includes the debts and assets of the individual, obtained from various organizations. The credit bureaus then provide the credit report to the bank or credit agency. The bank or credit agency may use the credit report from the credit bureaus to decide whether to loan money or extend credit to the individual.

Recently, organizations similar to the credit bureaus have begun to collect and distribute information associated with individuals beyond that of financial information. These organizations, known generally as data services, have begun to collect and distribute personal information. The personal information includes not only the financial information of an individual but also his medical records, health care, and legal documents. The individual typically provides the data services with the personal information. The data services may then authorize others to access the personal information.

### SUMMARY

The present invention stems from a realization of the difficulty of controlling access and accuracy to personal information managed by a data service. Typically, the data service and not the individual decides which businesses access the personal information and when the businesses access the personal information. Moreover, the individual may not know whether the personal information that the businesses obtain is accurate. Therefore, it would be more advantageous to have an efficient method and system for managing the personal information associated with the individual.

In accordance with a first principle aspect of the present invention, the data service may manage personal information associated with an individual. The data service may actively make sure that the personal information, e.g., financial records, medical records, confidential information, and trade secrets, is accurate so that businesses can rely on the personal information in making decisions.

The data service may have a computer and a local database. The computer may be coupled to a communications network, which allows the data service to access third-party databases such as Equifax, Trans Union, police databases, and FBI databases. When the individual subscribes to the data service, the individual may provide data that identifies the individual, such as a social security number, phone number, date of birth, or prearranged identification code. The data service may then use the data to gather personal information associated with the individual from the third-party databases coupled to the communications network.

The data service may determine if the personal information is accurate. If the personal information is accurate, then the personal information may be stored in the local database. If the personal information is not accurate, then the personal information may be not stored in the local database.

The data service may apply various tests to determine whether the personal information is accurate. The tests may involve determining whether the personal information is in more than one third-party database. Additionally or alternatively, the test may involve determining whether the personal information is in a reliable database, e.g., FBI database or police database.

The data service may also update the personal information that is stored in the local database. At predetermined times, the data service may gather the personal information associated with the individual from the third-party databases. Additionally, the data service may determine if the personal information already in the local database is accurate. The personal information in the local database may be compared with personal information in the third-party databases. If the personal information in the local database is in more than one third-party database or in a reliable database, then the personal information may be accurate. The data service may leave such personal information in the local database. If the personal information is not in more than one third-party database or is not in a reliable database, then the personal information may not be accurate. The data service may remove such personal information from the local database.

In accordance with a second principle aspect of the present invention, the individual may have ownership of the personal information stored in the local database. The individual may be able to control access to the personal information and be able to terminate his subscription with the data service.

The individual may control access to the personal information by authorization. If a business seeks access to the personal information associated with the individual, then the individual may identify all or a portion of the personal information to be granted access. The individual may grant access to a particular type of personal information managed by the data service, e.g., financial records or medical records. The data service may generate a one-time use access code and provide it to the individual. The one-time access code prevents unauthorized access to the personal information for more than one time. In turn, the individual may give the one-time use access code to the business. The business may then present the one-time use access code to the data service. Only then may the data service provide the personal information to the business.

The individual may terminate his subscription to the data service by sending an instruction to the data service along with identifying data. The instruction may have a unique code that identifies itself as a request to terminate the subscription. The data service may use the identifying information in the instruction to verify the identity of the individual. Then, the data service may retrieve the personal information stored in the local database that is associated with the individual. The individual may then be given the personal information that was retrieved. Moreover, the data service may remove all of the personal information stored in the local database that is associated with the individual.

In accordance with a third principle aspect of the present invention, an individual with a subscription to the data service may be able to selectively remove the personal information stored in the local database.

The process for selectively removing the personal information may depend on the type of the personal information: status information, public information, and private information.

If the personal information is status information such as a name or an address, then the personal information may be removed by request. The individual is typically trusted as a source for accurate status information.

The individual may remove public information such as property ownership, motor vehicle records, and criminal records and private information such as medical records, trade secrets, and confidential information by challenge. First, the individual may identify the public or private information to be removed. Second, the data service may determine whether the the public or private information is in the third-party databases. If the public or private information is not in more than one third-party database or not in a reliable database, then the data service may remove the public or private information from the local database. The public or private information may not be accurate.

If the public or private information is in more than one third-party database or in a reliable database, then the public or private information may be accurate. The individual, however, may request that a third-party, e.g., an arbitrator, be hired to review the determination of the data service. If the arbitrator finds that the private or public information also is accurate, then the individual may be allowed to add an explanation why he believes that the public or private information is still not accurate. If the arbitrator finds that the public or private information is actually not accurate, then the data service may remove the public or private information from the local database.

These as well as other aspects and advantages of the present invention will become apparent to those of ordinary skill in the art by reading the following detailed description, with appropriate reference to the accompanying drawings.

### BRIEF DESCRIPTION OF THE DRAWINGS

Exemplary embodiments of the present invention are described herein with reference to the drawings, in which:

FIG. 1 is an exemplary network architecture of a data service that obtains and stores personal information associated with individuals;

FIG. 2 is a flow diagram for a data service that allows an individual to control access to his personal information;

FIG. 3 describes several methods for determining accuracy of the personal information managed by the data service;

FIG. 4 is a flow diagram for active verification of the personal information managed by the data service;

FIG. 5 is a flow diagram for terminating a subscription to the data service;

FIG. 6 is a flow diagram for challenging public and private information managed by the data service; and

FIG. 7 is an exemplary explanation that the individual may add to a local database of the data service.

### DETAILED DESCRIPTION OF EXEMPLARY EMBODIMENTS

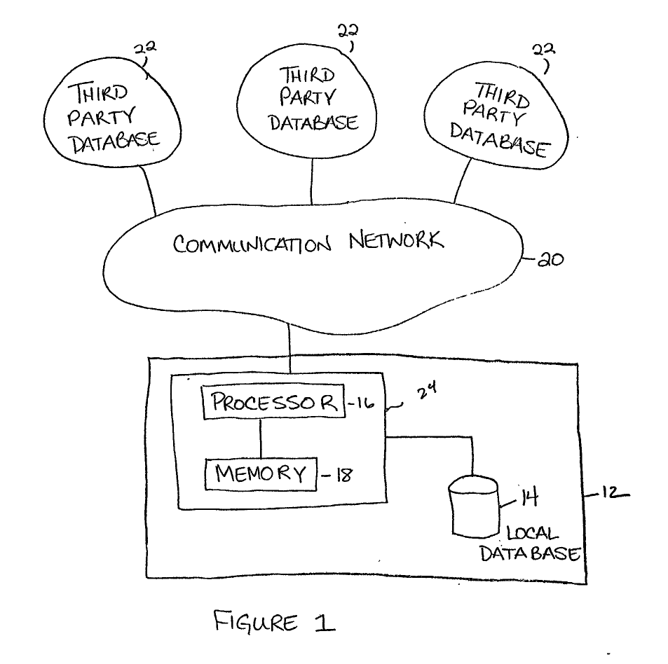

Referring to the drawings, FIG. 1 is an exemplary network architecture for a data service which manages personal information associated with an individual. Data services likened to FIG. 1 may be set up in various locations in a geographic area to manages the personal information associated with the individual.

Those skilled in the art will appreciate that other architectures for the data service can be used instead, additional elements may be added to these architectures, and some elements may be omitted altogether. Further, those skilled in the art will appreciate that many of the elements described herein are functional entities that may be implemented as discrete components or in conjunction with other components, in any suitable combination or location.

Still further, various functions described herein as being performed by one or more entities may be carried out by a processor programmed to execute an appropriate set of computer instructions stored in memory. Provided with the present disclosure, those skilled in the art can readily prepare the appropriate set of computer instructions (e.g., software) to perform such functions.

Referring to FIG. 1, the data service 12 may be a computer 24 that has a processor 16, a memory 18, and a local database 14. A communications network 20 (e.g., a telephone network or Internet) may couple the local database 14, e.g., a hard drive, a tape drive, and/or memory, to least one third-party database 22. The third-party databases 22 may be commercial or government databases such as Equifax, Trans Union, police databases, and FBI databases, which are preferably operated by parties not affiliated with the data service 12.

The local database 14 and the third-party databases 22 may collectively manage personal information associated with an individual. The personal information may be status information, public information, and/or private information. Status information may be information such as the individual's name, address, phone number, or social security number. Public information may be information managed by public organizations such as the individual's motor vehicle records and criminal records, for example. Private information may be information managed by private organizations such the individual's financial records, medical records, business methods, or trade secrets, for example.

The exemplary embodiments of the present invention assume that the data service stores personal information associated with individuals in the local database 14. The data service, however, may store other types of information that may not be considered “personal.” Moreover, the exemplary embodiments are not limited in that the personal information is about individuals and businesses request the personal information. The personal information may be about an entity, which includes both a business and an individual, and the entity may request the personal information. Other variations are also possible.

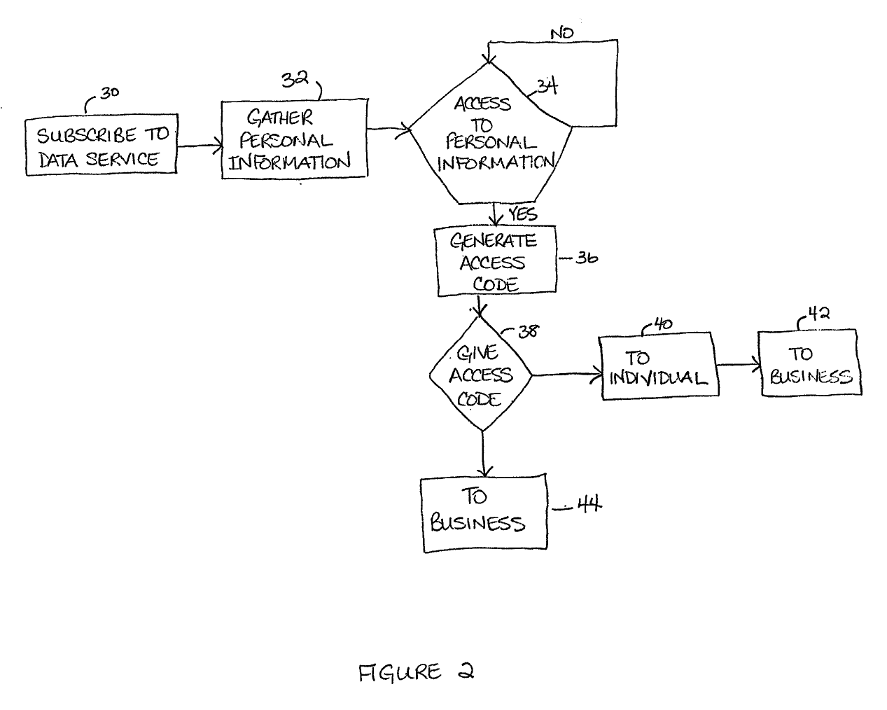

FIG. 2 illustrates a flow diagram for the data service. The data service may allow an individual to control access to his personal information stored in the local database 14. At block 30, the individual may subscribe to the data service. The individual may subscribe to the data service by providing data that identifies him, such as his name, birth date, address, and/or social security number. Alternatively, the individual may provide data in the form of a prearranged identification code which uniquely identifies the individual who is subscribing to the data service.

The data service may store the data that identifies the individual in the local database 14. Additionally, at block 32, the data service may use the data to gather personal information associated with the individual. The data service may gather the personal information associated with the individual from the third-party databases 22.

The data service may gather the personal information by sending an instruction over the communications network 20 to the third-party databases 22. The instruction may include a unique code (e.g., bit pattern) that identifies the instruction as a request for personal information associated with an individual, the data that identifies the individual, and a source address that identifies the data service. The third-party database 22 may receive the message and determine according to the source address whether the data service is authorized to receive the personal information associated with the individual. The third-party database 22 may access a list of data services that are authorized to access the personal information. If the source address of the data service is on the list, then the third-party database 22 may then use the data to determine whether it has personal information associated with the individual.

If the third-party database 22 does have personal information associated with the individual, then the third-party database 22 may send the personal information associated with the individual to the data service. The third-party database 22 may send the personal information over the communications network 20. Additionally, the data service 22 may send a database identifier that uniquely identifies the third-party database that provided the personal information. The data service may receive the personal information and store the personal information on the local database 14.

The data service may store the personal information in the local database 14 of the data service. The data service may, for example, make a copy of the personal information that was sent and place it in the local database 14. The personal information may also be stored with an indication that identifies that the personal information that is stored in the local database is associated with the individual. The data service may have a table that maps the data that identifies the individual to the indication of the individual. The table and the indication may be used to later locate the personal information associated with the individual that is stored in the local database 14.

Additionally or alternatively, the data service may store the personal information by reference. The data service may use the database identifier to establish a link to the third-party database 22 that has the personal information. The data service may use the link to later retrieve the personal information from the third-party database 22.

The data service may allow a business or other entity to access all or a portion of the personal information stored on the local database 14. At block 34, the individual may identify the personal information to be authorized access. For example, the individual may identify that access to his financial records be granted, but not his medical records. At step 36, the data service may generate an access code. The access code limits unauthorized access to the personal information. Preferably, the access code may be a one-time use code such as a password that permits the business access to the personal information one time. The access code may also specify a location of the data service (identifying one of the various data services in the geographic location) that may have the personal information of the individual.

At block 38, the individual may authorize to whom to give the access code. If the individual authorizes the data service to give the access code directly to a business, then the data service, at step 44, may provide the access code to the business. Alternatively, at step 40, the data service may provide the access code to the individual (or his agent) who will, in turn, at step 42, give the access code to the business. Either way, the individual exerts total control over when and what personal information the business may access.

When the data service receives the access code, the data service may check to determine if the access code is valid. The data service may compare the access code to a list of active access codes. If the access code is valid, then the data service may give the personal information to which the individual has granted access to the business. If the access code is a one-time use code, then the data service may then remove the access code from the list of active access codes. Consequently, no other entity may subsequently access the personal information from the data service using the access code.

The data service may be an active participant in the gathering and storage of the personal information associated with the individual. The data service may additionally make sure that the personal information that is stored in the local database 14 is also accurate.

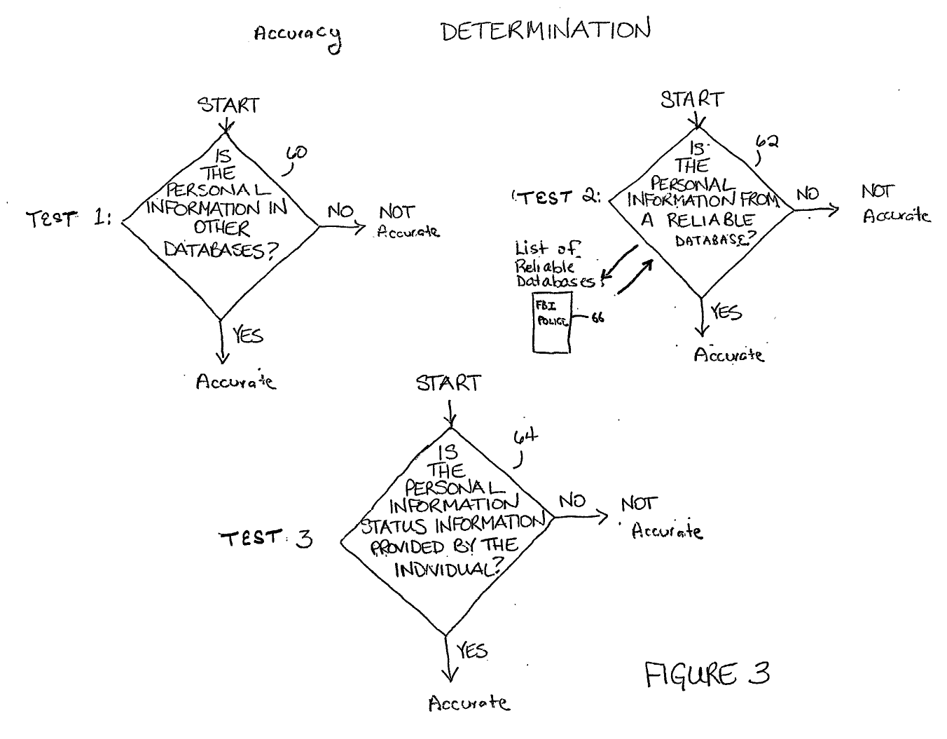

FIG. 3 describes several tests for determining whether the personal information is accurate. The determination may involve making sure that the personal information that is provided by one third-party database is also in another third-party database. Additionally or alternatively, the determination may involve making sure that the third-party database from which the data service receives the public or private information is reliable. Still additionally or alternatively, the determination may involve determining whether the personal information is status information.

At block 60, the data service may determine if personal information is in more than one third-party database. For example, the data service may determine whether the personal information from one third-party database 22 matches at least a portion of the personal information from another third-party database 22. If there is personal information that matches (i.e., same personal information is in at least two third-party databases), then that personal information may be accurate. If there is personal information that does not match (i.e., particular personal information does not exist in more than one third-party database 22), then the personal information may not be accurate.

At block 62, the data service may consider the reliability of the third-party database having the personal information. The data service may have a list of reliable databases 66 such as FBI databases and police databases. The data service may use the database identifier that is received in the message having the personal information to determine whether the personal information is from a reliable database. If the database identifier is on the list of reliable databases 66, then the personal information may be accurate. If the data service finds that the personal information is not in on the list of reliable databases 66, then the personal information may not be accurate.

At block 64, the data service may determine if the personal information is status information provided by the individual. If the personal information is status information provided by the individual, then the personal information may be inherently accurate.

The data service may not only verify the accuracy of the personal information when it is initially stored in the local database 14. The data service may actively verify the personal information stored in the local database 14 to reflect changes in the personal information. For example, the data service may check for new legal actions against the individual such as the individual being convicted of a crime or whether the individual has violated terms of a loan agreement. The data service may update the personal information in the local database 14 as appropriate.

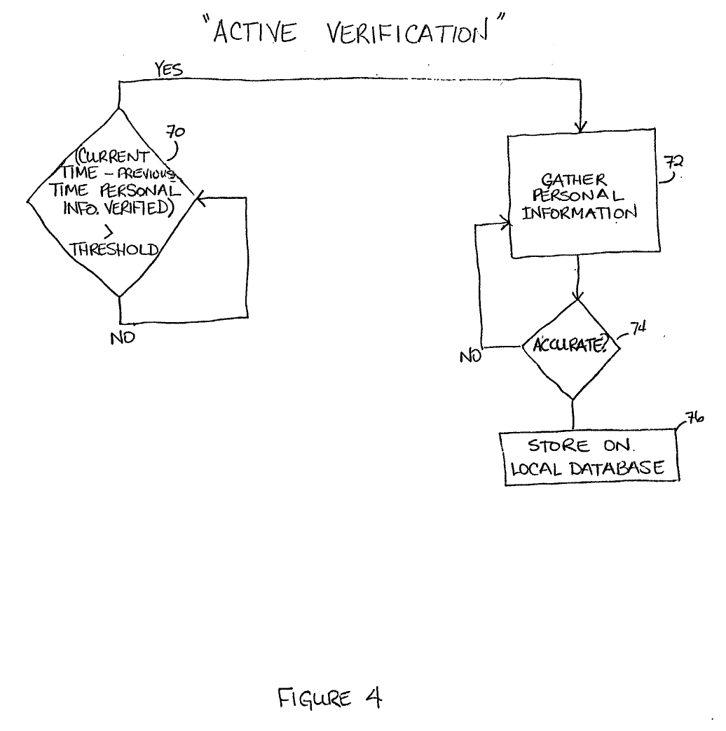

FIG. 4 illustrates a flow diagram for active verification of the personal information. A timer on the computer 12 may indicate a previous time that the personal information in the local database 14 was verified. The timer may also indicate a current time, e.g., a present day of the year. At block 70, a determination is made as to how long it has been since the personal information has been verified. For example, a difference may be calculated between the previous time and the current time. If the difference is greater than a threshold, then at block 72, the data service may gather personal information associated with the individual from the third-party databases 22. The data service may verify at block 74 that the personal information is in more than one third-party database 22 or is in a reliable database. If the personal information is in more than one third-party database 22 or in reliable database, then the personal information may be accurate. At block 76, the data service may store the personal information in the local database 14, preferably if the personal information is not already in the local database 14.

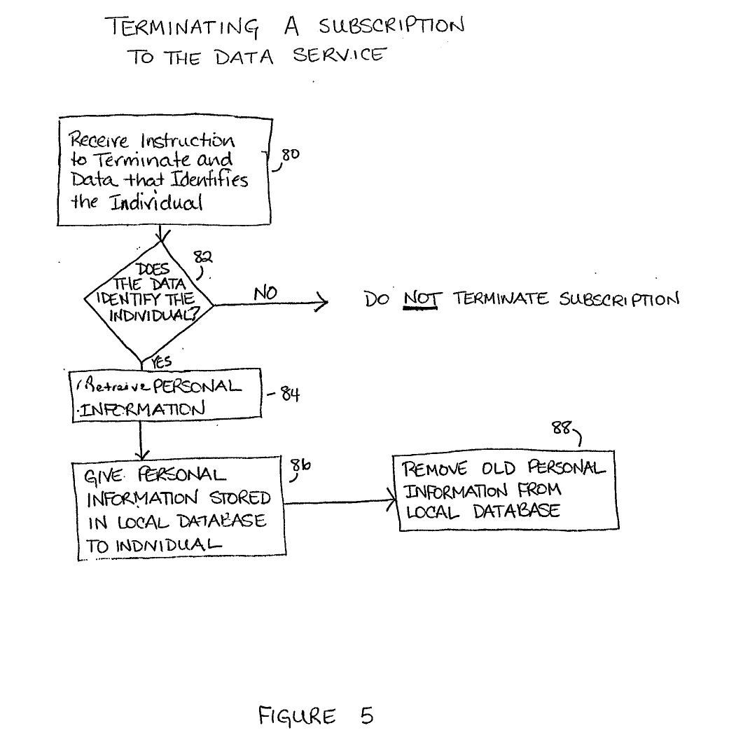

FIG. 5 is a flow diagram for terminating an individual's subscription to the data service. The individual may terminate his subscription to the data service at any time. Terminating the subscription ensures security of the personal information associated with the individual. No other business can subsequently access the personal information that is stored on the local database 14.

If the subscription to the data service is to be terminated, then at block 80, the individual may send an instruction to request termination to the data service. The instruction may have a unique code (e.g., a bit pattern) that identifies the instruction as a request to terminate the subscription. The individual may also give to the data service the data that identifies him. At block 82, the data service may use the data to verify the identity of the individual. The data service may compare the data to what is stored in the local database 14 to make sure that it is, in fact, the individual (or his agent) who is requesting to terminate the individual's subscription to the data service. If the identity of the individual is verified, then at block 84, the data service may retrieve all of the personal information stored in the local database that is associated with the individual.

The data service may retrieve the personal information stored in the local database 14 by, for example, using the table that maps the data that identifies the individual to the indication that identifies the personal information stored in the local database that is associated with the individual. The data service may search the local database 14 for the personal information that has the indication. If the data service finds personal information with the indication, then the personal information is personal information associated with the individual. Of course, other arrangements are also possible for retrieving the personal information stored in the local database that is associated with the individual.

At block 86, the individual may be given the personal information that is retrieved from the local database 14. The data service may give the personal information to the individual in an electronic format (e.g., a diskette) or in a paper format, for example. The data service may then remove, at block 88, the personal information stored on the local database that is associated with the individual. For example, the data service may overwrite the locations on the local database 14 that has the personal information that is to be removed thereby deleting the personal information from the local database 14. As a result, the data service does not retain any personal information associated with the individual. Moreover, the individual, by possession, controls the personal information that was stored on the local database.

Assuming that the individual has not terminated his subscription to the data service, the user may be allowed to selectively remove personal information in the local database 14. The individual may selectively remove personal information from the local database 14 that is not accurate.

The ability of the individual to selectively remove the personal information may depend on the type of personal information, e.g., status information, public information, or private information. The individual may be allowed to remove status information by request. The individual may be the most reliable source of the status information. The individual may remove public and private information from the local database upon a successful challenge as to the accuracy of the public information or private information.

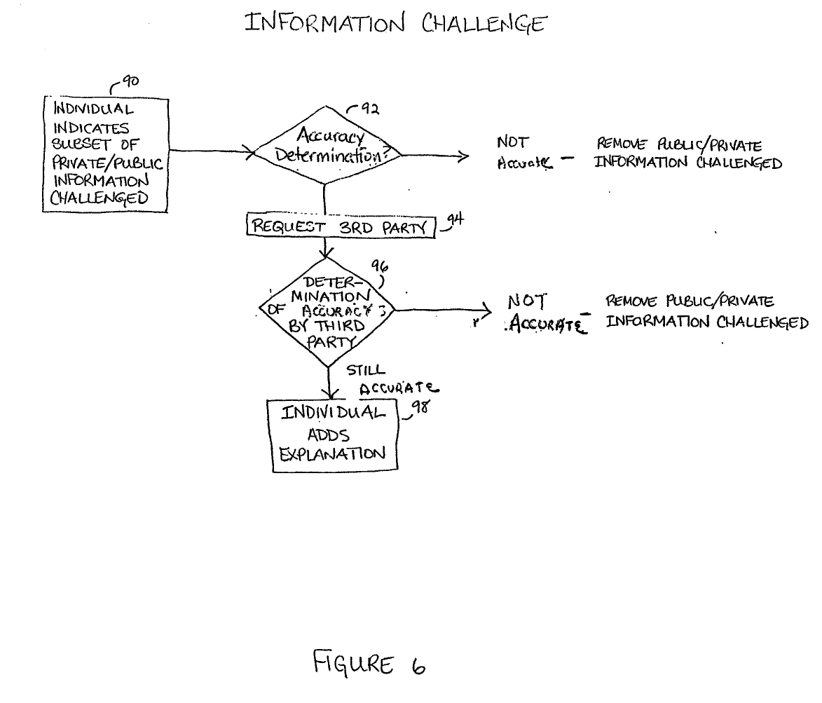

FIG. 6 illustrates a flow diagram for challenging personal information that is either public information or private information stored in the local database 14. If the individual challenges public or private information, then at block 90, the individual may identify the public or private information to be challenged, e.g., in an instruction. At step 92, the data service may determine the accuracy of the public or private information. The data service may, for example, gather personal information associated with the individual from the at least one third-party database 22 and determine whether the public or private information identified by the individual is in a reliable database or in more than one third-party database 22.

If the public or private information is not in more than one third-party database 22 or not in a reliable database, then the public or private information may not be accurate. The data service may remove the public or private information from the local database 14.

If the public or private information is in more than one third-party database 22 or in a reliable database, then the public or private information may be accurate. The individual may request at block 94 that a third-party, e.g., arbitrator, review the determination of the data service. If the arbitrator decides at block 96 that the public or private information is not accurate, then the public or private information may be removed from the local database 14. Alternatively, if the arbitrator decides, contrary to the determination of the data service, that the public or private information is accurate, then at block 96, the individual may add an explanation to the public or private information.

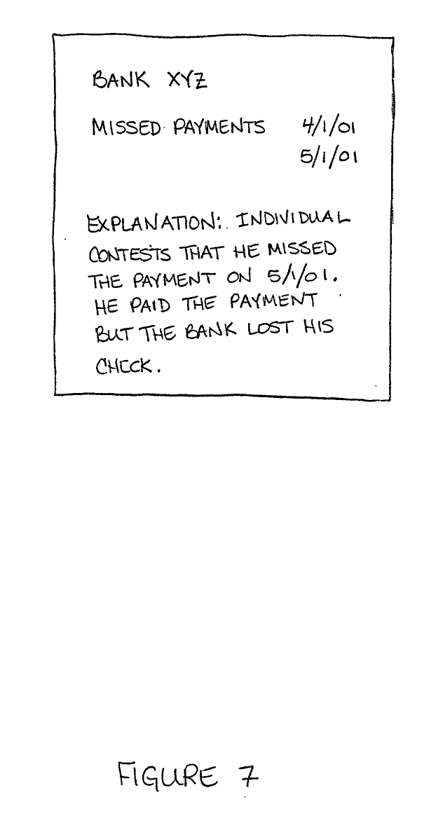

FIG. 7 illustrates an exemplary explanation that the individual may add to the local database 14. The explanation may be a note, for example, that explains why the individual believes the public or private information is inaccurate. The individual, however, may not remove any public or private information from the local database 14.

The exemplary embodiments of the present invention, as described, enable the individual sole control over the access of his personal information. Consider the following as one illustration of the operation of the present invention:

1) Individual contacts a data service and provides the data service with his name and social security number, or date of birth, or prearranged identification number generated either by the individual or the data service.

2) The data service gathers personal information on the individual and stores it in its local database.

3) A bank requests the credit information of an individual in order to process a loan application.

4) The individual contacts his data service and identifies the bank to be granted access to his credit information.

5) The data service generates an access code to access the credit information (e.g. bankruptcy, late payments) and either:

a) Gives the bank the access code needed to access the credit information.

b) Gives the individual the access code. In turn, the individual gives the access code to the bank to access the credit information.

6) The bank uses the access code to access the credit information. This access would include the ability to add new data and read existing data.

It is to be understood that the embodiments herein described are merely illustrative of the principles of the present invention. Various modifications may be made by those skilled in the art without departing from the spirit and scope of the exemplary embodiments.

We claim:

1. A method for a data service to manage personal information of an entity, the method comprising:
obtaining a first personal information of the entity and at least one data that identifies the entity;
based on the at least one data that identifies the entity, gathering a second personal information of the entity from at least one third-party database;
determining whether the first personal information matches at least a portion of the second personal information; and
storing matched personal information in a local database of the data service.

2. The method of claim 1, further comprising:
receiving an access code from a separate entity, the access code allowing access to at least a portion of the matched personal information stored in the local database;
determining whether the access code authorizes the separate entity to access the at least a portion of the matched personal information; and
providing the at least a portion of the matched personal information to the separate entity if the access code authorizes the separate entity to access the matched personal information.

3. The method of claim 2, wherein the access code identifies the data service from a plurality of data services.

4. The method of claim 2, wherein the access code is usable for one time.

5. The method of claim 1, wherein the at least one data is selected from the group consisting of a name, social security number, a birth date, and a prearranged identification code.

6. The method of claim 1, wherein the first personal information is obtained from the entity.

7. The method of claim 1, wherein the first personal information is obtained from the at least one third-party database.

8. The method of claim 1, wherein the at least one data is obtained from the entity.

9. The method of claim 1, further comprising:
(i) receiving an instruction from the entity to remove stored personal information in the local database of the data service;
(ii) based on the instruction, determining whether the stored personal information is status information, public information, or private information;
(a) based on the stored personal information being status information:
removing the stored personal information from the local database of the data service;
(b) based on the stored personal information being private information or public information:
(i) gathering separate personal information from the at least one third-party database;
(ii) determining whether the separate personal information matches at least a portion of the stored personal information;
(iii) hiring a third-party if the separate personal information matches the at least a portion of the stored personal information; and
(iv) removing the stored personal information from the local database based on a decision by the third-party.

10. The method of claim 9, wherein removing the stored personal information comprises overwriting locations in the local database having the stored personal information.

11. The method of claim 9, further comprising adding an explanation to the local database if the stored personal information matches the at least a portion of the separate personal information, the explanation being added by the entity.

12. The method of claim 9, wherein the instruction is received from the entity.

13. The method of claim 1, further comprising:
receiving an instruction from the entity to terminate a subscription to the data service;
retrieving the matched personal information that is stored in the local database of the data service;
providing the matched personal information to the entity; and
removing the matched personal information stored in the local database so only the entity has the matched personal information.

14. The method of claim 13, wherein removing the matched personal information comprises overwriting locations in the local database having the matched personal information.

15. The method of claim 1, further comprising:
determining whether a difference between a current time and a previous time is greater than a threshold, the previous time identifying when the matched personal information in the local database was verified;
gathering separate personal information from the at least one third-party database if the difference between the previous time and the current time is greater than the threshold;
determining whether at least a portion of the separate personal information matches the matched personal information; and
storing the at least a portion of the separate personal information in the local database of the data service if the at least a portion of the separate personal information does not match the matched personal information.

16. A method for a data service to manage personal information of an entity, the method comprising:
obtaining at least one data that identifies the entity;
based on the at least one data that identifies the entity, gathering the personal information of the entity from at least one third-party database;
determining whether the at least one third-party database is on a list of reliable databases; and
based on the at least one third-party database being on the list of reliable databases, storing the personal information gathered from the at least one third-party database in a local database of the data service.

17. The method of claim 16, further comprising:
receiving an access code from a separate entity, the access code allowing access to at least a portion of the personal information stored in the local database;
determining whether the access code authorizes the separate entity to access the at least a portion of the personal information; and
providing the at least a portion of the personal information to the separate entity if the access code authorizes the separate entity to access the at least a portion of the personal information.

18. The method of claim 17, wherein the access code identifies the data service from a plurality of data services.

19. The method of claim 17, wherein the access code is usable for one-time.

20. The method of claim 16, wherein the at least one data is selected from the group consisting of a name, social security number, a birth date, and a prearranged identification.

21. A system for a data service, the system comprising:
a processor;
memory;
a communications network;
a local database, the local database being coupled to the communications network;
at least one third-party database, the at least one third-party database being coupled to the communications network;
computer instructions stored in the memory and executable by the processor for performing the functions of:
(a) obtaining a first personal information of an entity and at least one data that identifies the entity;
(b) based on the at least one data that identifies the entity, gathering a second personal information of the entity from the at least one third-party database;
(c) determining whether the first personal information matches at least a portion of the second personal information; and
(d) storing matched personal information in the local database of the data service.

22. The system of claim 21, wherein the computer instructions stored in the memory and executable by the processor further perform the function of:
receiving an access code from a separate entity, the access code allowing access to at least a portion of the matched personal information stored in the local database;
determining whether the access code authorizes the separate entity to access the at least a portion of the matched personal information; and
providing the at least a portion of the matched personal information to the separate entity if the access code authorizes the separate entity to access the matched personal information.

23. The system of claim 21, wherein the computer instructions stored in the memory and executable by the processor further perform the functions of:
(i) receiving an instruction from an entity to remove stored personal information in the local database of the data service;
(ii) based on the instruction, determining whether the stored personal information is status information, public information, or private information;
(a) based on the stored personal information being status information:
removing the stored personal information from the local database of the data service;
(b) based on the stored personal information being private information or public information:
(i) gathering separate personal information from the at least one third-party database;
(ii) determining whether the separate personal information matches at least a portion of the stored personal information;
(iii) hiring a third-party arbitrator if the separate personal information matches the at least a portion of the stored personal information; and
(iv) removing the stored personal information from the local database based on a determination by the third-party arbitrator.

24. The system of claim 21, wherein the computer instructions stored in the memory and executable by the processor further perform the functions of:
receiving an instruction from the entity to remove stored personal information in the local database of the data service;
retrieving the matched personal information stored in the local database of the data service;
providing the matched personal information to the entity; and
removing the matched personal information stored in the local database so that the entity has the matched personal information.

25. A system for a data service, the system comprising:
a processor;
memory;
a communications network;
a local database, the local database being coupled to the communications network;
at least one third-party database, the at least one third-party database being coupled to the communications network;
computer instructions stored in the memory and executable by the processor for performing the functions of:
(i) obtaining at least one data that identifies the entity;
(ii) based on the at least one data that identifies the entity, gathering the personal information of the entity from the at least one third-party database;
(iii) determining whether the at least one third-party database is on a list of reliable databases; and
(v) based on the at least one third-party database being on the list of reliable databases, storing the personal information gathered from the at least one third-party database in the local database of the data service.

26. The system of claim 25, wherein the computer instructions stored in the memory and executable by the processor further perform the functions of:
receiving an access code from a separate entity, the access code allowing access to at least a portion of the personal information stored in the local database;
determining whether the access code authorizes the separate entity to access the at least a portion of the personal information; and
providing the at least a portion of the personal information to the separate entity if the access code authorizes the separate entity to access the at least a portion of the personal information.
